(19) United States
(12) Patent Application Publication
(10) Pub. No.: US 2008/0007713 A1
(43) Pub. Date: Jan. 10, 2008

(54) Optical Input Device and Method of Measuring Relative Movement of an Object and an Optical Input Device

(75) Inventor: Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/568,418

(22) PCT Filed: Apr. 26, 2005
(86) PCT No.: PCT/IB05/51361

§ 371 Date: Oct. 27, 2006

(30) Foreign Application Priority Data
Apr. 29, 2004 (EP) 04101833.4

(51) Int. Cl. G01J 3/00; G06F 3/033

(52) U.S. Cl. 356/51; 356/450

(57) ABSTRACT

An optical input device for measuring the movement of an object (15), e.g. a finger, is accommodated in a housing provided with a transparent window (12) for transmitting a measurement beam (13) from a diode laser (3) to the object (15) and radiation reflected by the object (15) to a detector, wherein changes in the operation of the laser cavity caused a laser diode self-mixing effect indicate the extent and direction of movement of the object. The angle of incidence (α) and/or the refractive index of the transparent window (12) nₗₑₙₛ are selected so that at least a significant proportion of the measuring beam (13) is substantially totally internally reflected by the transparent window (12) when the object (15) is not in contact therewith. A device is also described in which at least a portion of the measuring beam (13) is directed toward a second transparent window (36) to provide a laser pointing function or enable the projection of messages or images.

This invention relates to a relative movement sensor for use, for example, in an optical input device, for measuring movement of an object (for example, a user's finger) and the sensor relative to each other. The sensor comprising at least one laser, having a laser cavity, for generating a measuring beam and illuminating an object therewith, wherein at least some of the measuring beam radiation reflected by the object re-enters the laser cavity, wherein measuring means are provided for measuring changes in operation of the laser cavity caused by interference reflected measuring beam radiation re-entering the laser cavity and the optical wave in that cavity.

The invention also relates to a method of manufacturing such a sensor, an optical input device including such a sensor, and a method of measuring movement of an object and such a sensor relative to each other.

An optical input including a relative movement sensor as defined is known from International Patent Application No. 02/37410, which describes a method of measuring the relative movement of an input device and an object, for example, a human finger or other object, which method uses a so-called self-mixing effect in a diode laser. This is the phenomenon that radiation emitted by a diode laser and re-entering the cavity of the diode laser induces a variation in the gain of the laser and thus in the radiation emitted from the laser. Radiation emitted by a diode laser is focussed through, for example, a plastic lens on an external object (e.g. a fingertip). The light scatters and a small part re-enters the cavity of the laser. Here, the light that is cattered mixes coherently with the light inside the cavity, which changes the gain and frequency of the laser. This self-mixing can be detected and converted to represent the direction and speed of a moving object such as a fingertip.

The optical input device of International Patent Application No. 02/37410 comprises a transparent window through which the object, such as a human finger, is illuminated. It will be appreciated that, under some circumstances, at least some of the laser light will be visible to a user through the transparent window when there is no object between the transparent window and the user's line of sight, and it is known that laser light can be harmful to a user's eyes. Therefore, there may at least be a perception by the user that the laser light visible through the transparent window may be harmful to their eyes.

It is an object of the present invention to overcome the above-mentioned problem, and provide a relative movement sensor which is less likely to cause a user harm or to have a perception that the laser light used therein is harmful to them.

In accordance with a first aspect of the present invention, there is provided a relative movement sensor for measuring movement of an object and the sensor relative to each other, the sensor comprising a transparent window and at least one laser, having a laser cavity, for generating a measuring beam and illuminating an object therewith through the transparent window when the object is in contact with a surface of the transparent window, wherein at least some of the measuring beam radiation reflected by the object re-enters the laser cavity, the apparatus further comprising measuring means for measuring changes in operation of the laser cavity caused by interference of reflected measuring beam radiation re-entering the laser cavity and the optical wave in the laser cavity, wherein the angle of incidence of the measuring beam on the transparent window and/or the refractive index of the transparent window are such as to cause a significant proportion of the measuring beam radiation incident on the transparent window to be substantially totally internally reflected thereby in the absence of an object in contact therewith.

The first aspect of the present invention also extends to an optical input device including such a sensor, a method of measuring movement of an object and such a sensor relative to each other, and a method of manufacturing such a sensor including the step of selecting the angle of incidence of the measuring beam on the transparent window and/or the refractive index of the transparent window so as to cause a significant proportion of the measuring beam radiation incident on the inner surface of the transparent window to be substantially totally internally reflected thereby in the absence of any object in contact therewith.

It will be appreciated that, in the case where a focused beam is used as the measuring beam, this measuring beam impinges on the surface of the window with a (finite) range of angles, due to the focusing action. Thus, in this case, the measuring beam would be constituted by more than one ray.

Beneficially, the angle of incidence of the measuring beam, or at least a significant proportion of the rays constituting such a beam, and/or the refractive index of the transparent window, are selected such that at least 50%, and more preferably 90%, of the radiation incident on the transparent window is reflected back therefrom. In one preferred exemplary embodiment, the measuring beam incident on the transparent window is substantially totally internally reflected thereby in the absence of an object in contact therewith. It will be appreciated by a person skilled in the art that, for example, substantially the same benefit can be achieved if the angle of incidence of the measuring beam on the transparent window, and/or the refractive index of the transparent window are selected such that, say, 90% or more of the radiation incident on the transparent window is reflected thereby and only less than 10% of the incident radiation is actually permitted to pass therethrough. In this case, where the measuring beam is constituted by a number of rays of radiation at a range of angles, all but one or two of those angles (for example) may be such as to effect substantially total internal reflection of the respective rays by the transparent window, and then only some predetermined percentage of the above-mentioned one or two rays may be allowed to pass through the transparent window, the remaining portion thereof also being reflected back. The manner in which the angle(s) of incidence and/or the refractive index of the transparent window can be selected to achieve the desired result will be apparent to a person skilled in the art.

In a preferred embodiment, the angle of incidence of the measuring beam (α) on the transparent window is such that sin(α)>1/nₗₑₙₛ, where nₗₑₙₛ is the refractive index of the transparent window.

The angle of incidence of the measuring beam (or a significant proportion of the rays constituting the measuring beam) on the transparent window may be at least partially set by the location of the laser relative to the transparent window, and/or the area of the laser from which the laser light is emitted. The angle of incidence of the measuring beam on the transparent window may be at least partially controlled by one or more reflective elements, such as mirrors, located in the radiation path of the measuring beam; one or more refractive elements located in the radiation path of the measuring beam; one or more diffractive elements, such as diffraction gratings, located in the radiation path of the measuring beam; and/or one or more wave guiding elements, such as focussing grating couplers, located in the radiation path of the measuring beam.

The sensor may further comprise optical means for converging the measuring beam (or a significant proportion of the rays constituting it) in an action plane, wherein the upper surface of the transparent window is convex in at least one of two mutually perpendicular directions in the action plane on top of the transparent window. The advantage of this feature is that if the window has a convex surface shape in at least one direction, it can be kept clean, especially in its central part where the measuring beam passes. In addition, the window is tangible so that it can be more easily found by the user, even in the dark.

It is another object of the present invention, to utilize the laser light employed in the relative movement sensor for another purpose, particularly in the case of a portable optical device wherein it is crucial to minimize the size of the overall unit to promote its portability.

Thus, in accordance with a second aspect of the present invention, there is provided a portable optical device comprising a relative movement sensor for measuring movement of an object and the sensor relative to each other, the sensor comprising a first transparent window and at least one laser, having a laser cavity, for generating a measuring beam and illuminating an object therewith through the transparent window, wherein at least some of the measuring beam radiation reflected by the object re-enters the laser cavity, the sensor further comprising measuring means for measuring changes in operation of the laser cavity caused by interference of reflected measuring beam radiation re-entering the laser cavity, the device further comprising a second transparent window, and means for causing at least a portion of the measuring beam to be output from the device through the second transparent window.

The light being output through the second transparent window may, for example, provide a laser pointing function, or enable the projection of messages or images from said device using diffractive patterns in the beam.

The device may comprise beam-splitting means for causing some of the measuring beam to be directed toward the first transparent window and some of the measuring beam to be directed toward the second transparent window.

Alternatively, at least a portion of the measuring beam reflected by the first transparent window may be directed toward the second transparent window for output therethrough. The angle of incidence of the measuring beam on the first transparent window and/or the refractive index of said first transparent window may be such as to cause the measuring beam radiation incident on the first transparent window to be substantially totally internally reflected thereby in the absence of an object in contact therewith, following which total internal reflection, the measuring beam is directed toward the second transparent window. The at least a portion of the measuring beam may be directed toward the second transparent window via collimating means, following reflection thereof by the first transparent window. In one embodiment, the angle of incidence α of the measuring beam on the first transparent window is beneficially such that sin(α)>1/nₗₑₙₛ, where nₗₑₙₛ is the refractive index of the first transparent window, so as to effect the above-mentioned substantial total internal reflection of the measuring beam by the first transparent window.

The measuring beam may comprise infra-red laser light, or it may comprise, for example, blue or green laser light so as to enhance the visual effect of the laser pointing function.

These and other aspects of the present invention will be apparent from, and elucidated with reference to the embodiments described herein.

Embodiments of the present invention will now be described by way of examples only and with reference to the accompanying drawings, in which:

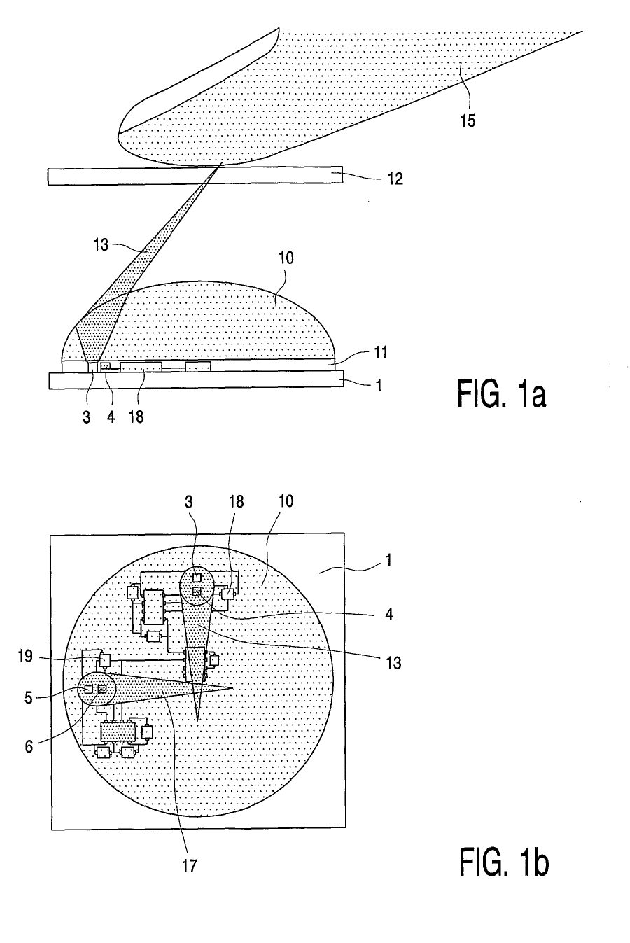

FIG. 1a is a schematic cross-sectional view of an optical input device of the type described in International Patent Application No. 02/37410, to illustrate the principle of operation of an optical input device according to an exemplary embodiment of the present invention;

FIG. 1b is a plan view of the device of FIG. 1a;

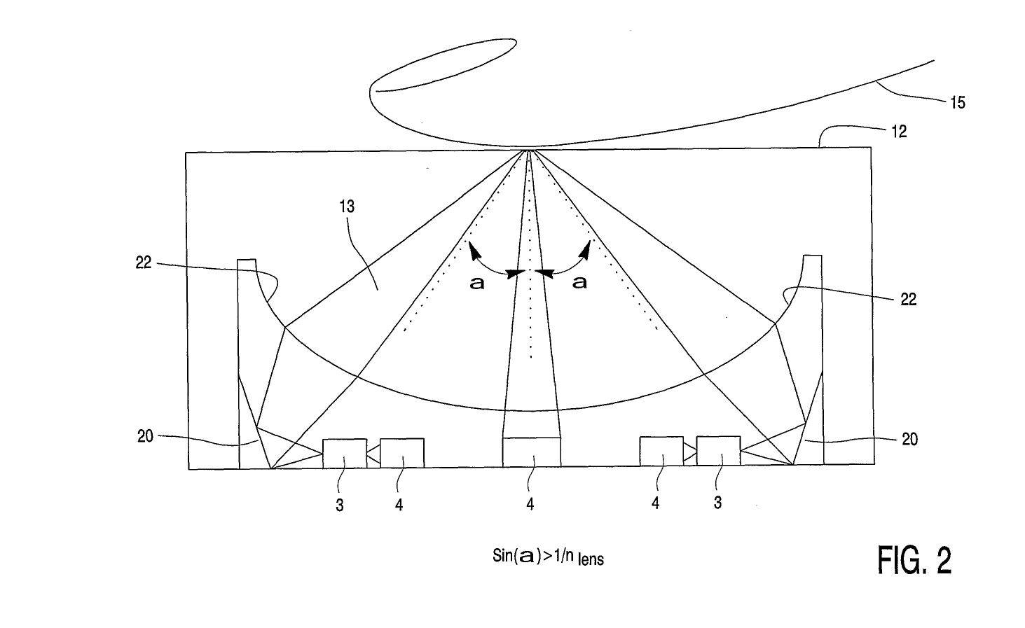

FIG. 2 is a schematic cross-sectional view of a relative movement sensor in accordance with a first exemplary embodiment of the present invention;

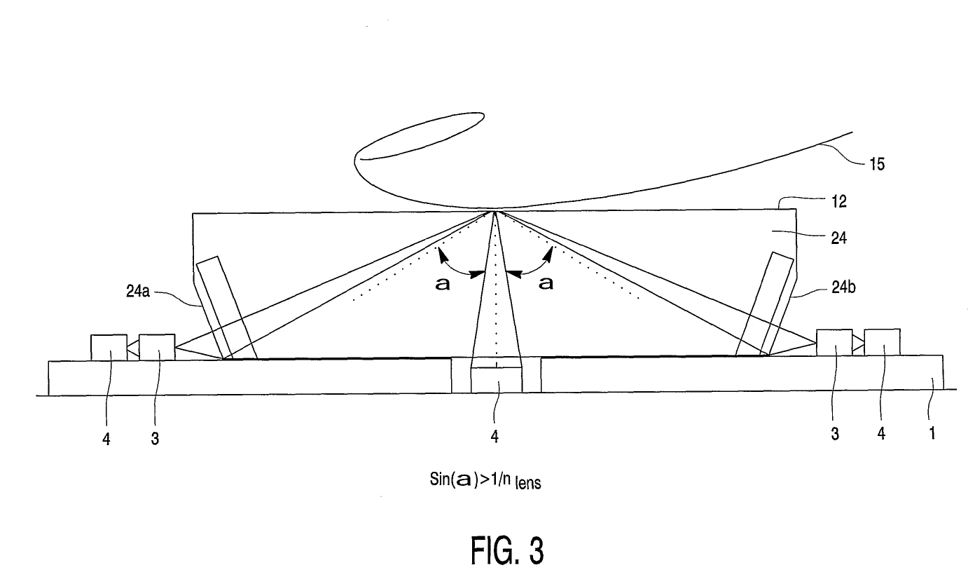

FIG. 3 is a schematic cross-sectional view of a relative movement sensor in accordance with a second exemplary embodiment of the present invention;

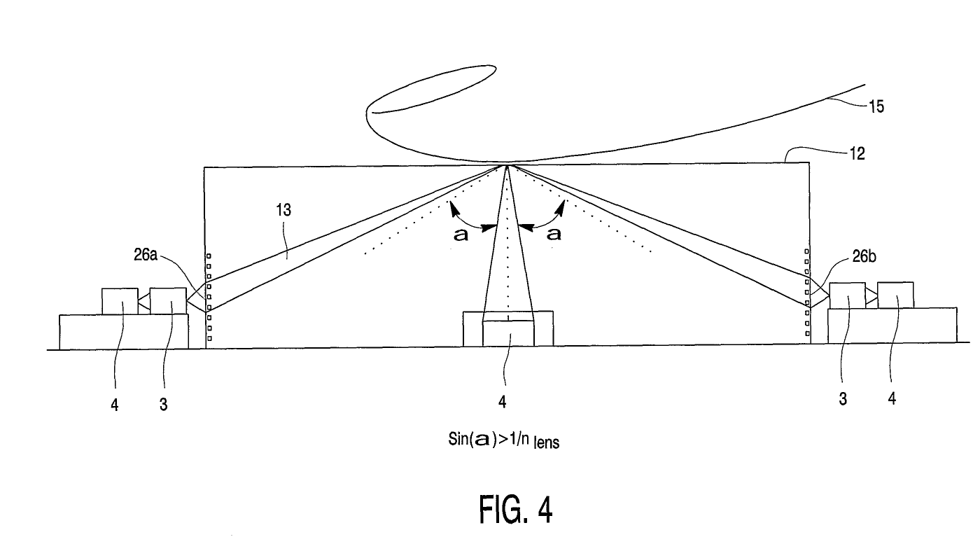

FIG. 4 is a schematic cross-sectional view of a relative movement sensor in accordance with a third exemplary embodiment of the present invention;

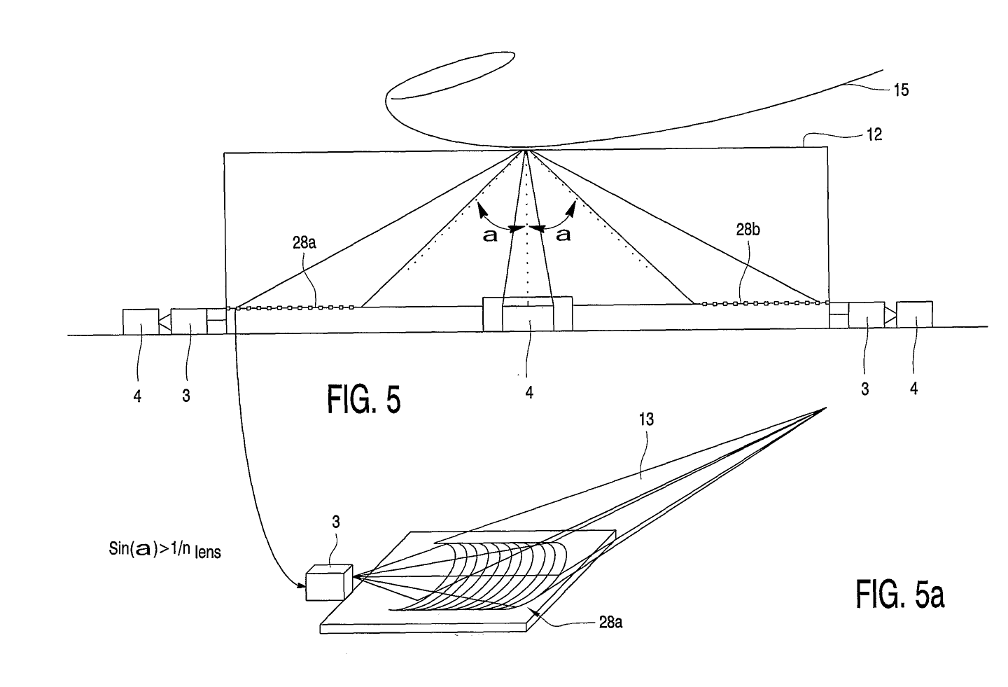

FIG. 5 is a schematic cross-sectional view of a relative movement sensor according to a fourth exemplary embodiment of the present invention;

FIG. 5a is a schematic perspective view of the principal of operation of a planar wave guide focusing grating coupler used in the embodiment illustrated in FIG. 5 of the drawings;

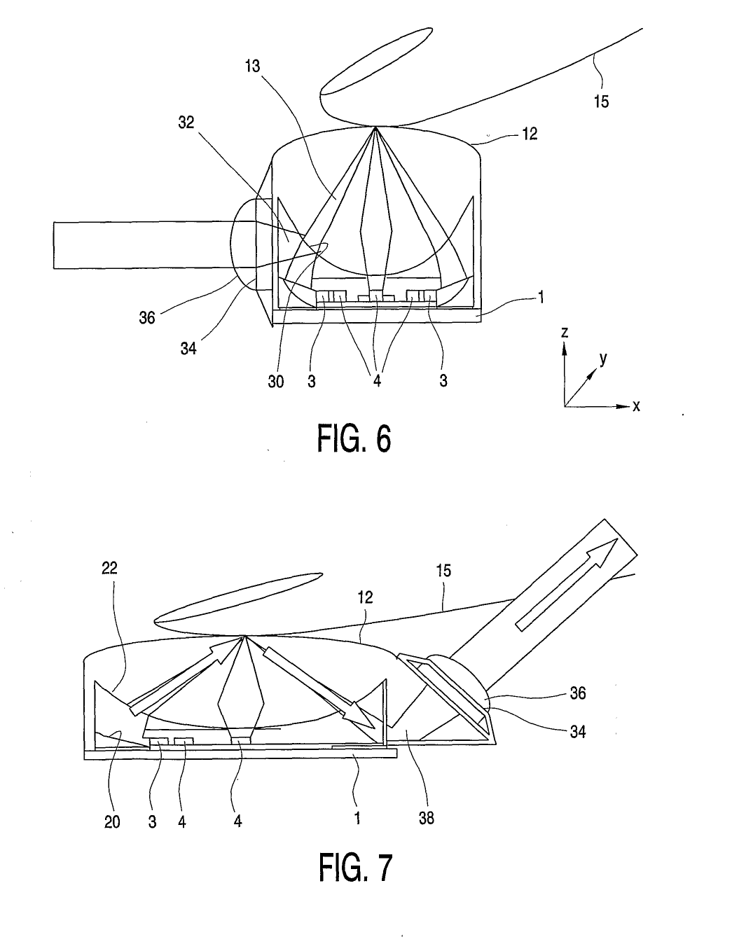

FIG. 6 is a schematic cross-sectional view of a portable optical device according to a first exemplary embodiment of a second aspect of the present invention; and

FIG. 7 is a schematic cross-sectional view of a portable optical device according to a second exemplary embodiment of a second aspect of the present invention.

FIG. 1 is a diagrammatic cross-section of an optical input device comprising, at its lower side, a base plate 1, which is a carrier for the diode lasers, which may be lasers of the Vertical Cavity Surface Emitting Laser (VCSEL) type, and the detectors, for example, photo diodes. In FIG. 1a only one diode laser 3 and its associated photo diode is visible, but usually at least a second diode laser 5 and associated detector 6 is provided on the base plate 1, as shown in FIG. 1b of the drawings. The diode lasers 3, 5 emit laser, or measuring, beams 13 and 17 respectively. At its upper side, the device is provided with a transparent window (e.g. plastic lens) 12 across which an external object 15, for example, a human fingertip is to be moved. A lens 10, for example, a plano-convex lens is arranged between the diode lasers and the window. This lens focuses the laser beams 13, 17 at or near the upper side of the transparent window. If an object 15 is present at this position, it scatters the beam 13, 17. A part of the radiation of beam 13, 17 is scattered in the direction of the illumination beam 13, 17 and this part is converged by the lens 10 on the emitting surface of the diode laser 3, 5 and re-enters the cavity of this laser. The radiation re-entering the cavity induces a variation in the gain of the laser and thus in the radiation emitted by the laser. This phenomenon will also be ferred to herein as the so-called self-mixing effect in a diode laser.

The finger and the input device are moved relative to each other such that the direction of movement has a component in the direction of the laser beam. Upon movement of the finger and the input device, the radiation scattered by the object gets a frequency different from the frequency of the radiation illuminating the object, because of the Doppler effect. Part of the scattered light is focused on the diode laser by the same lens that focuses the illumination beam on the finger. Because some of the scattered radiation enters the laser cavity through the laser mirror, interference of light takes place in the laser. This gives rise to fundamental changes in the properties of the laser and the emitted radiation. Parameters, which change due to the self-coupling effect, are the power, the frequency and the line width of the laser radiation and the laser threshold gain. The result of the interference in the laser cavity is a fluctuation of the values of these parameters with a frequency that is equal to the difference of the two radiation frequencies. This difference is proportional to the velocity of the fingertip. Thus, the velocity of the fingertip and, by integrating over time, the displacement of the fingertip, can be determined by measuring the value of one of the above-mentioned parameters.

The change of intensity of the laser radiation emitted by the diode laser as a result of relative movement between the fingertip and the input device can be detected by the photo diode 4, 6, which converts the radiation variation into an electric signal, and electronic circuitry 18, 19 is provided for processing this electric signal.

The principle of the relative movement sensor and method of measuring relative movement employed in the present invention is described in further detail in International Patent Application No. 02/37410, and will not be described in any further detail herein.

The optical input device described in International Patent Application No. 02/37410 may be employed, for example, as a compact, laser-based scrolling device or integrated optical micro-mouse without mechanical moving parts in mobile telephones, Personal Digital Assistants (PDA's) and the like. However, in current designs, focussed coherent laser beam radiation may radiate out of the device housing (through the transparent window) and this radiation, depending on the laser power (which, in respect of one known device, might typically be around 1 mW), creates either a real potential danger to the human eye or an unrealistic “presumed” (by users and/or relevant authorities) danger to the eye.

As indicated above, a first aspect of the present invention relates to a relative movement sensor, wherein the angle of incidence of the measuring beam on the transparent window and/or the refractive index of the transparent window are such as to cause the measuring beam incident on the transparent window to be substantially totally internally reflected thereby in the absence of an object in contact therewith.

This may be achieved, in accordance with this exemplary embodiment of the present invention, by increasing the angle at which light is focussed on the transparent window to a value above a critical angle α, as illustrated schematically in FIG. 2 of the drawings. At such a high angle of incidence, substantial total internal reflection (TIR) will occur at the interface between the (e.g. plastic) transparent window 12, which will prevent the light from propagating out of the housing when the window 12 is not in contact with a fingertip 15 or other object. This total internal reflection will stop when a fingertip 15 or other object touches the window 12 because the refractive index of skin tissue is relatively close to that of the window (n˜1.4). In other words, the introduction of a fingertip or other object in contact with the transparent window, creates so-called frustrated TIR which is caused by a change in refractive index at the window/fingertip interface (compared with that of the window/air interface), such that light still scatters when a fingertip is in contact with the window, and a detectable signal is still generated and the principal of operation remains unchanged without the potential danger of laser light being emitted from the housing of the device.

In addition to the prevention of escape of any laser light from the device, the increased angle of incidence of the measuring beam has the additional advantage of enabling the design to be made very compact.

In a preferred embodiment, the angle of incidence ∀ of the measuring beam hitting the transparent window 12 is set such that sin(∀)>1/nₗₑₙₛ, where nₗₑₙₛ is the refractive index of the transparent window 12. In the exemplary embodiment of the present invention illustrated in FIG. 2 of the drawings, this is achieved by the provision of a mirror 20 and a refractive lens 22 in the radiation path of the measuring beam 13. However, it will be apparent to a person skilled in the art that many different designs for achieving the desired effect are possible, which designs may be obtained using, for example, known software for optimizing a merit function of an optical device, such as ZEMAX (RTM) or the like.

For example, in the exemplary device illustrated schematically in FIG. 3 of the drawings, instead of the mirror 20 and the refractive lens 22, only a refractive lens 24, having lens surface 24a and 24b, is required to create a measuring beam 13 having an angle of incidence ∀ on the transparent window 12 such that sin(α)>1/nₗₑₙₛ.

In the exemplary embodiment of the invention illustrated schematically in FIG. 4 of the drawings, diffraction grating or Fresnel structures are appropriately placed to achieve the desired angle of incidence, and in the exemplary embodiment of the invention illustrated schematically in FIG. 5 of the drawings, appropriately placed wave guiding/diffracting elements in the form of planar wave guide with focusing grating couplers 28a, 28b are used to achieve the desired angle of incidence. The operation of the wave guides with focusing couplers 28a, 28b can be seen more clearly in the detail diagram provided in FIG. 5a of the drawings.

In all cases described above, the laser diodes used are edge-emitting diodes, which are fairly conducive to the provision of a compact design. However, the use of edge-emitting lasers is not essential to the present invention, and the optical means used to provide the desired angle of incidence of the measuring beam may be adjusted according to the type of radiation source employed.

In all cases, it is beneficial for the upper surface of the transparent window 12 to be concave in at least one of two mutually perpendicular directions. In the event that the transparent window is, say, flat, dust and dirt particles may gather on the window and especially on its central part, where the measuring beam(s) should pass. This dust and dirt may have an impact on the measuring beam(s) and thus may influence the measurement results, which is obviously undesirable. In addition, a small amount of dust, dirt or grease may cause scattering of the measuring beam, thereby undermining the total internal reflection, and permitting a small amount of light to pass through the window. If the window has a convex surface shape, in at least one direction, it can be kept clean, especially in its central part where the measuring beam passes, as described in more detail in International Patent Application No. WO 02/37411.

As indicated above, a second aspect of the present invention relates to a portable optical device including a relative movement sensor of the type described above, the device further comprising a second transparent window, and means for causing at least a portion of the measuring beam to be output from the device through the second transparent window so as to provide a laser pointing function.

The optical input device described in International Patent Application No. 02/37410 may be employed, for example, as a compact, laser-based scrolling device or integrated optical micro-mouse without mechanical moving parts in mobile telephones, PDA's and the like. The second aspect of the present invention proposes the use of the laser diode(s) of the optical input device not only as the light source for the input device, but also such that at least part of the laser light emitted therefrom can be used to provide a laser pointing function in the device, at (almost) no additional manufacturing cost.

This may be achieved by collimating (part of) the non-scattered light with, for example, a plastic curved optical surface that may be integrated on the side of the optical input device lens. The collimated laser beam may then be emitted from a separate window in, for example, a mobile telephone or the like, to be used as a laser pointing function or to project messages or images using diffractive patterns in the beam.

Referring to FIG. 6 of the drawings, in a first exemplary embodiment of the second aspect of the present invention, light coming directly from the laser diode 3 may be split by beam splitting means 30 into two beams: a measuring beam 13 for the optical input device, and another beam 32 which is collimated (at 34) and output through a second transparent window 36.

Referring to FIG. 7 of the drawings, in an alternative exemplary embodiment of the second aspect of the present invention, the angle of incidence of the measuring beam may be such that, in the absence of an object in contact with the first transparent window, the measuring beam is substantially totally internally reflected by the first transparent window, as in the case of the first aspect of the present invention, as described in detail above. Any one of the designs described with reference to FIGS. 2, 3, 4 or 5, or any other alternative design as will be apparent to a person skilled in the art, may be used to achieve this effect. The reflected measuring beam can then be directed (by, for example, a reflective element 38) to the second transparent window 36 to be output therethrough.

In one embodiment, infra-red laser may be used. However, alternatively, red, green, blue or other colored laser diodes may be used to enhance the visual effect, if desired.

Means (not shown) are preferably provided for selectively preventing the output of radiation through the second transparent window, as desired. In its simplest form, such means may comprise a shutter or similar mechanical means for blocking the radiation path from the second transparent window. In another embodiment, a variable focus lens or “electrowetted” lens (such as that described in International Patent Application No. 2003/069380) may be employed, whereby the lens selectively either focuses the laser for effecting the optical input device function or it focuses it towards, for example, a collimator lens for output through the second transparent window so as to provide, for example, a laser pointing function or enable messages or images to be projected using diffractive patterns in the beam.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A relative movement sensor for measuring movement of an object (15) and said sensor relative to each other, the sensor comprising a transparent window (12) and at least one laser (3), having a laser cavity, for generating a measuring beam (13) and illuminating an object (15) therewith through said transparent window (12) when said object is in contact with a surface of said transparent window (12), wherein at least some of the measuring beam radiation reflected by said object (15) re-enters said laser cavity, the apparatus further comprising measuring means (4) for measuring changes in operation of said laser cavity caused by interference of reflected measuring beam radiation re-entering said laser cavity and the optical wave in said laser cavity, wherein the angle of incidence (α) of said measuring beam (13) on said transparent window (12) and/or the refractive index of said transparent window (12) are such as to cause at least a significant proportion of said measuring beam radiation incident on said transparent window (12) to be substantially totally internally reflected thereby in the absence of an object (15) in contact therewith.

2. A sensor according to claim 1, wherein at least 50% of said measuring beam incident on said transparent window (12) is substantially totally internally reflected thereby in the absence of an object in contact therewith.

3. A sensor according to claim 3, wherein at least 90% of said measuring beam radiation incident on said transparent window (12) is substantially internally reflected thereby in the absence of an object in contact therewith.

4. A sensor according to claim 1, wherein said angle of incidence (α) of said measuring beam (13) on said transparent window (12) is such that sin(α)>1/nₗₑₙₛ, where nₗₑₙₛ is the refractive index of the transparent window (12).

5. A sensor according to claim 1, wherein the angle of incidence (α) of the measuring beam (13) on the transparent window (12) is at least partially set by the location of said laser (3) relative to said transparent window (12).

6. A sensor according to claim 1, wherein the angle of incidence (α) of the measuring beam (13) on the transparent window (12) is at least partially controlled by one or more reflective elements (20) located in the radiation path of said measuring beam (13).

7. A sensor according to claim 6, wherein said one or more reflective elements comprise at least one mirror (20).

8. A sensor according to claim 1, wherein the angle of incidence (α) of the measuring beam (13) on the transparent window (12) is at least partially controlled by one or more refractive elements (22, 24a, 24b) located in the radiation path of said measuring beam (13).

9. A sensor according to claim 1, wherein the angle of incidence (α) of the measuring beam (13) on the transparent window (12) is at least partially controlled by one or more diffractive elements (26a, 26b) located in the radiation path of said measuring beam (13).

10. A sensor according to claim 9, wherein said one or more diffractive elements comprise at least one diffraction grating (26a, 26b).

11. A sensor according to claim 1, wherein the angle of incidence (α) of the measuring beam (13) on the transparent window (12) is at least partially controlled by one or more wave guiding elements (28a, 28b) located in the radiation path of said measuring beam.

12. A sensor according to claim 11, wherein the one or more wave guiding elements comprise at least one focussing grating coupler (28a, 28b).

13. A sensor according to claim 1, further comprising optical means (10) for converging said measuring beam (13) in an action plane, wherein the upper surface of the transparent window (12) is convex in at least one of two mutually perpendicular directions in the action plane on top of the transparent window (12).

14. An optical input device including a sensor according to claim 1.

15. A method of measuring movement of an object (15) and a sensor relative to each other, the sensor comprising a transparent window (12) and at least one laser (3), having a laser cavity, for generating a measuring beam (13) and illuminating an object (15) therewith through said transparent window (12) when said object (15) is in contact with a surface of said transparent window (12), wherein at least some of the measuring beam radiation reflected by said object (15) re-enters said laser cavity, the method comprising means (4) for measuring changes in operation of said laser cavity caused by interference of reflected measuring beam radiation re-entering said laser cavity and the optical wave in said laser cavity, wherein the angle of incidence (α) of said measuring beam (13) on said transparent window (12) and/or the refractive index of said transparent window (12) are such as to cause at least a significant proportion of said measuring beam radiation incident on said transparent window (12) to be substantially totally internally reflected thereby in the absence of an object (15) in contact therewith.

16. A method of manufacturing a sensor according to claim 1, comprising arranging a laser (3), having a laser cavity, relative to an inner surface of a transparent window (12) so as to generate a measuring beam (13) for illuminating an object (15) therewith through said transparent window (12) when an object (15) is in contact with an upper surface of said transparent window (12), wherein at least some of the measuring beam radiation reflected by said object (15) re-enters said laser cavity, the method further comprising providing measuring means (4) for measuring changes in operation of said laser cavity caused by interference of reflected measuring beam radiation re-entering said laser cavity and the optical wave in said laser cavity, and selecting the angle of incidence (α) of said measuring beam (13) on said transparent window (12) and/or the refractive index of said transparent window (12) so as to cause at least a significant proportion of said measuring beam radiation incident on said inner surface of said transparent window (12) to be substantially totally internally reflected thereby in the absence of an object (15) in contact therewith.

17. A portable optical device comprising a relative movement sensor for measuring movement of an object (15) and said sensor relative to each other, the sensor comprising a first transparent window (12) and at least one laser (3), having a laser cavity, for generating a measuring beam (13) and illuminating an object (15) therewith through said first transparent window (12), wherein at least some of the measuring beam radiation reflected by said object (15) re-enters said laser cavity, the sensor further comprising measuring means (4) for measuring changes in operation of said laser cavity caused by interference of reflected measuring beam radiation re-entering said laser cavity and the optical wave in said laser cavity, the device further comprising a second transparent window (36), and means for causing at least a portion of said measuring beam to be output from said device through said second transparent window (36).

18. A device according to claim 17, further comprising beam splitting means (30) for causing some of said measuring beam (13) to be directed toward said first transparent window (12) and some of said measuring beam (13) to be directed toward said second transparent window (36).

19. A device according to claim 17, wherein at least a portion of the radiation emitted from said laser (3) reflected from said first transparent window (12) is directed toward said second transparent window (36) for output therethrough.

20. A device according to claim 19, wherein the angle of incidence (α) of said measuring beam (13) on said first transparent window (12) and/or the refractive index of said first transparent window (12) are such as to cause said measuring beam radiation incident on said first transparent window (12) to be substantially totally internally reflected thereby in the absence of an object (15) in contact therewith, following which total internal reflection said measuring beam is directed toward said second transparent window (36).

21. A device according to claim 20, wherein said at least a portion of said measuring beam is directed toward said second transparent window (36) via collimating means (34), following reflection thereof by said first transparent window (12).

22. A device according to claim 19, wherein said angle of incidence (α) of said measurement beam (13) on said first transparent window (12) is such that sin(α)>1/nₗₑₙₛ, where nₗₑₙₛ is the refractive index of the first transparent window (12).

23. A device according to claim 1, wherein said measuring beam (13) comprises infra-red, blue or green laser light.
